(19) United States
(12) Patent Application Publication
(10) Pub. No.: US 2010/0133358 A1
(43) Pub. Date: Jun. 3, 2010

(54) Spraying device

(76) Inventor: Alfred Göhring, Salem (DE)

Correspondence Address: Scott R. Foster;Pandiscio & Pandiscio, P.C., 470 Totten Pond Road, Waltham, MA, 02451, US

(21) Appl. No.: 12/590,086

(22) Filed: Nov. 2, 2009

(30) Foreign Application Priority Data
Nov. 3, 2008 (EP) 08019161.2

(51) Int. Cl. B05B 9/04

(52) U.S. Cl. 239/337

(57) ABSTRACT

A high volume-low pressure spraying device for viscous media, such as paint. The device is adapted to spray highly viscous media with relatively low air pressure and low flow resistance.

The present invention relates to a spraying device in accordance with the pre-characterising clause of patent claim 1 or 2.

Spraying devices of this kind have been marketed for decades by the patent registrant as well as by competitors as what are referred to as “high volume—low pressure” (HVLP) spraying systems. HVLP systems have to date normally used air pressures from about 50 to 689 hectopascals (hPa) in order to force the paint out of the reservoir in the direction of the outlet opening and to atomise it after it has left the outlet opening, as well as to orientate it as a flat jet or the like. If, however, the paint to be pumped has a high viscosity (in other words, of the paint is extremely thick) then it becomes more difficult to move this viscous medium in sufficient quantity out of the reservoir in the direction of the outlet opening, because the resistance to flow increases in the riser pipe and in the delivery line that emerges in the outlet opening.

The HVLP systems on the market either have a blower inserted in the gun housing by means of which the ambient air is forced into the inside of the gun housing in order to generate the positive pressure of 50 to 689 hPa prevailing there, or the HVLP systems are connected to a blower or another compressed air source through a hose, by means of which the air pressure required for processing the medium is achieved inside the gun housing.

In all HVLP systems available on the market, the inner diameter of the riser pipes through which the medium to be processed is transported into the delivery line inside the spray gun has a value that is between about 6 and 8 mm. The inside diameter of the outlet opening into which the delivery line emerges is between 2.0 and 4.0 mm in conventional HVLP systems. The cross-sectional area of the riser pipe through which the flow moves is accordingly about 38.5 mm² and the cross-sectional area of the outlet opening is about 3.15 to 12.56 mm².

In order to increase the delivery volume of the medium to be processes, the power of the blower is increased by providing single or multiple stage blowers that contain one or more rotors. For example, Graco offers three HVLP systems with different power levels, namely HVLP 2500 (two-stage), 3800 (three-stage) and 4900 (four-stage). This now enables media with a higher viscosity to be processed, because low-viscosity media require less power in order to be sprayed, compared to a highly viscous medium.

The application range of single and two-stage blowers is therefore limited in the upper direction, and specifically with regard to processing highly viscous media. If, however, a multiple-stage blower is available then although it does allow both low and high-viscosity media to be sprayed, multiple-stage blowers do however require much more energy in order to produce the power. Furthermore, blowers of this kind take up a lot of space and their operation generates a significant noise level. Multiple-stage blowers are therefore significantly more expensive to manufacture and to maintain than a single or two-stage blower. As a result, each medium with different viscosities requires a particular kind of blower in order for the medium to be sprayed in an energy efficient manner and with the lowest possible noise level.

Conventional HVLP systems, therefore, suffer from the disadvantage that the delivery volume is adapted to the viscosity of the medium to be processed by means of the power increase of the blower. Manufacturers of commercially available HVLP systems normally use relatively high air pressures in order to provide an adequate delivery volume of the medium to be processed when highly viscous media are going to be sprayed. The manufacturers do not undertake any design changes on or in the spray gun, because the power increase of the individual blowers is, based on other developments of many years' standing, sufficient for providing the necessary delivery volume.

A further disadvantage of conventional HVLP systems lies in the fact that the length of the delivery section provided for the paint is extremely long. In particular, the distance between the outlet opening and the inlet opening of the riser pipe in the paint delivery line is often made as long as possible in order to locate the outlet opening away from the plane formed by the reservoir.

Even in light of the Hagen-Poiseuille formula developed around 1860, manufacturers of paint spray guns and HVLP systems have to date not been able to design a paint spray gun with a sufficient delivery volume for highly viscous media with regard to known fluid mechanics, without having to increase the blower power. Rather, the manufacturers of HVLP systems of prior art have resorted to the method of achieving the positive pressure inside the paint spray gun by increasing the power of the blower.

Furthermore, the manufacturers of HVLP systems of prior art have often offered a particular pairing between the valve needles inserted into the outlet opening and the cross-sectional area of the outlet opening of the paint nozzle. This design measure is intended to achieve a situation in which media with different viscosities can be processed. However, the highly viscous medium initially has to be transported and moved through the riser pipe and then through the delivery line, therefore it is not sufficient to increase the ring gap between the valve needle and the inside contour of the outlet opening, because the flow resistance values in the riser pipe and in the paint delivery line prevent the delivery volume being increased by this design measure. An increase in the paint delivery volume is exclusively achieved in the HVLP systems of prior art through the power of the blower being adapted to the highly viscous media by means of two or more rotors being driven by the blower.

Furthermore, inside the gun housing, the riser pipe is often pushed into a pipe neck that is formed onto the spray gun and emerges directly in the delivery line. Therefore, it is not possible to increase the cross-sectional area of the riser pipe in a straightforward manner.

The purpose of the present invention is therefore to configure a spray gun of the aforementioned kind in such a way that, firstly, highly viscous media can be sprayed without increasing the blower power used for pumping the medium out of a reservoir into the spray gun and, secondly, the delivery volume is pumped to the outlet opening with the lowest possible flow resistance.

These tasks are achieved in accordance with the present invention by means of the features described in the characterising parts of patent claims 1 and/or 2.

Further advantageous embodiments are disclosed in the subordinate claims.

The cross-sectional area of the riser pipe is at least 80 mm² or, preferably, 200 mm², therefore this guarantees that the medium to be processed that is contained in the reservoir can be pumped through the riser pipe with a lower flow resistance, with the result that while the blower power remains the same, i.e. constant, a correspondingly sufficient volumetric flow of the medium is provided through the riser pipe towards the outlet opening of the delivery line.

It is particularly advantageous if the ratio between the cross-sectional area of the riser pipe and the cross-sectional area of the outlet opening to be between 16 and 196, and preferably between 25 and 41, because this means the volumetric flow of the medium to be processed can be pumped evenly along the entire length of the delivery section, without impeding the flow. As a result, an optimum cross-sectional area is provided for the entire delivery section through which the medium flows and the power applied by the blower for commercially available spray guns is sufficient even for processing highly viscous media that have an elevated flow resistance due to their viscosity.

The drawing shows a sample embodiment configured in accordance with the present invention, the details of which are explained below. In the drawing,

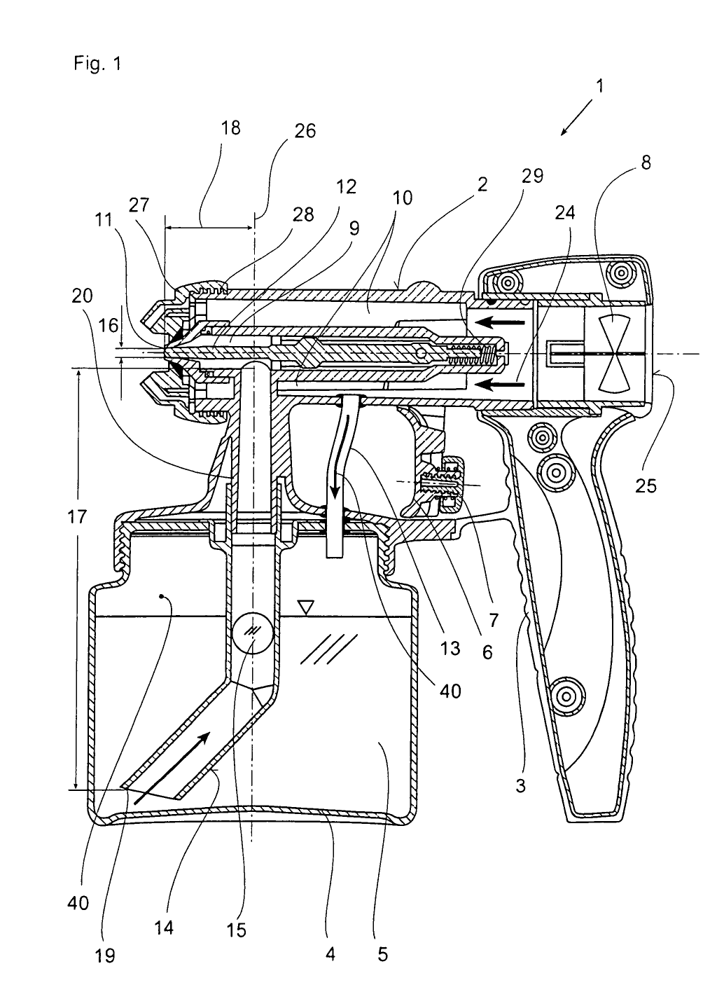

FIG. 1 shows a spray gun with a gun housing which has a handle and a removable reservoir attached to it, in which the medium to be processed is filled, with provision of a delivery line that emerges in an outlet opening and a ring duct in which a flow of air generated by a blower flows towards the outlet opening, in which case the outlet opening is shown in the closed condition and

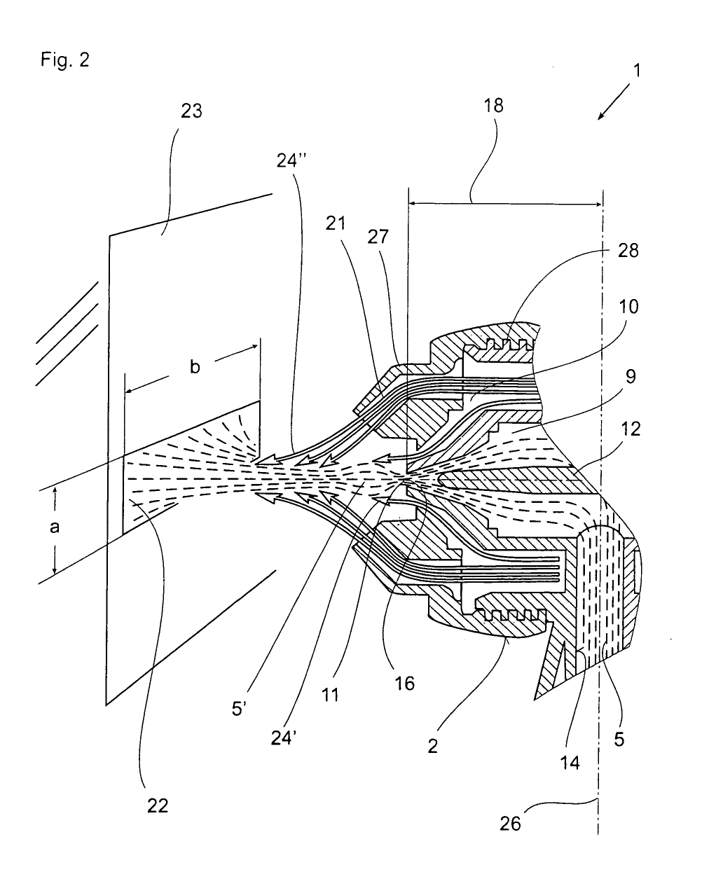

FIG. 2 shows the spray gun in accordance with FIG. 1 in the area of the outlet opening, in the open condition.

FIG. 1 shows a spray gun 1 comprising a gun housing 2 to which a handle 3 and a reservoir 4 are removably attached. The reservoir 4 contains a highly viscous medium 5 that is to be processed by the spray gun 1, in particular paints for painting walls and ceilings.

A trigger lever 6 is mounted on the gun housing 2 in a pivoting arrangement between the handle 3 and the reservoir 4, and the trigger lever 6 has an adjustment travel that can be limited by a setscrew 7 aligned in the direction of the handle 3. By means of intermediate elements that are not shown, the trigger lever 6 is in a non-positive connection with a valve body 12 that is axially mobile inside the gun housing 2 so, as a result, the valve body 12 can be moved against the force of a spring 29 when the trigger lever 6 is moved in the direction of the handle 3.

In order to pump the medium 5 from out of the reservoir 4 for the purpose of processing, there is an inlet opening 25 worked into the end face of the gun housing 2 and a blower 8 is provided inside the gun housing 2. The blower 8 therefore draws air from the surroundings through the inlet opening 25 and forces it into the inside of the gun housing 2, as is explained in more detail below. The blower 8 and the inlet opening 25 can be replaced by a hose that is connected to a corresponding blower or another suitable source of compressed air.

A circular delivery line 9 is provided inside the gun housing 2 which has the valve body 12 inserted in it so that the delivery line 9 and the valve body 12 run in axial alignment with one another. The delivery line 9 emerges in an outlet opening 11 that is closed by the valve body 12 when the trigger lever 6 is not actuated.

The delivery line 9 is surrounded by a ring duct 10 that communicates with the blower 8 in such a way that the quantity of air drawn in by the blower 8 is transported through the ring duct 10 towards the outlet opening 11 without however coming into connection with the inside of the delivery line 9. The blower 8 generates a positive pressure in the ring duct of about 50 to 689 hPa in relation to the ambient outside air pressure. A pressure level of this kind is referred to in the technical jargon as HVLP=high volume low pressure.

Part of the jet of air 24 drawn in by the blower is deflected through a hose 13 in the area of the ring duct 10. The hose 13 is attached between the ring duct 10 and the inside of the reservoir 4 an emerges there, with the effect that the positive pressure prevailing in the ring duct 10 is channelled into the inside of the reservoir 4 by means of the hose 13 and creates a correspondingly high backpressure there, by means of which the medium 5 filled in the inside of the reservoir 4 can be transported into the delivery line 9 via a riser pipe 14.

The riser pipe 14 consists of a pipe neck 19 removably attached to the reservoir 4 and of a supply neck 20 formed on the gun housing 2. The inner diameter of pipe neck 19 in this case is selected to be sufficiently large for it to be able to be pushed over the outer diameter of supply neck 20. As a result, pipe neck 19 and supply neck 20 can be separated from one another in order to allow these parts to be cleaned well.

FIG. 2 shows a desired spray pattern 22 on a wall 23. The spray pattern should have a rectangular shape in order for the wall 23 to be sprayed with the medium 5 over a wide area using vertical or horizontal movements. To make this possible, there are two flow ducts 21 arranged on the side next to the outlet opening and are arranged at diametrically opposite positions. In the area of the outlet opening 11, there is an air flap 27 screwed onto a male thread 28 worked onto the outside of the gun housing 2. The two flow ducts 21 are worked into the inside of the air flap 27 and communicate with the ring duct 10 so that the air forced into the ring duct 10 is directed towards the outside through the flow ducts 21.

The valve body 12 is shown in an open position in FIG. 2 so that the outlet opening 11 is open. The pressure 40 prevailing in the riser pipe 14 and in the delivery line 9 means that the medium 5 flows out of the reservoir 4 and the delivery line 9 in the direction of the outlet opening 11 and is atomised as a result of the jet of air 24′ surrounding the outlet opening 11. The flow ducts 21 and the jet of air 24′ and 24″ acting through these on the spray jet 5′ of the medium 5 cause the jet of air 24′ and 24″ to be shaped in accordance with the spray pattern 22, atomised into ultrafine particles and pressed together so that the required rectangular shape of the spray jet 5′ is produced in the area of the wall 23. The position of the air flap 27 is not defined with reference to the gun housing 2 and its orientation can be changed.

The paint 5 filled in the reservoir 4 is initially thick or highly viscous and is pumped in fluid form through the riser pipe 14 to the outlet opening 11. The air proportions 24′ of the jet of air 24 emerging at the sides pick up and atomise droplets of paint so that the paint/jet of air mixture created in this way is provided with the reference number 5′.

The jets of air 24″ emerging from the horns compress the paint/air mixture 5′ so that the rectangular spray pattern 22 results.

In order to transport the delivery volume of the medium 5 to be processed from the reservoir 4 to the outlet opening 11 with a delivery pressure of the jet of air 24 that is as low as possible, the cross-sectional area of the riser pipe 14 is at least 150 mm² and preferably 200 mm² over its entire length. The diameter of the outlet opening 11 is 2.5 mm, meaning that the cross-sectional area 16 of the outlet opening 11 is 4.9 mm². This means that the ratio between the cross sections of the cross-sectional area 16 of the outlet opening 11 and the cross-sectional area 15 of the riser pipe 14 is between 31 and 41. The configuration of the design of the cross-sectional surfaces through which the medium 5 is to be transported outwards results, in a preferred embodiment, in the situation that, given the same power level of the blower 8, a sufficient fluid flow of the medium 5 can be generated without having to increase the power that has to be applied to the blower 8 during the pumping of highly viscous media 5.

Furthermore, the entire length of the delivery section 17 of the riser pipe 14 and the delivery section 18 of the delivery line 9 is maximum 250 mm. In particular, the delivery section 18 of the delivery line 9 is kept as short as possible. This means the outlet opening 11 is arranged as close as possible to the discharge point of the riser pipe 14 into the gun housing 2. The delivery section 18 of the delivery line 9 should be between 30 and 60 mm in length in this case.

If the riser pipe 14 has a diameter of 10.1 mm, the cross-sectional area 15 of flow in the riser pipe 14 is approx. 80 mm². Even with such a geometrical dimension of the riser pipe 14, it is possible to establish that there are positive flow effects that lead to the power to be applied to the blower 8 being able to be kept almost constant even when highly viscous media are being processed, so that there is no need for a significant increase in power for the blower 8 for driving several rotors.

A precise upper limit on the cross-sectional area 15 of flow in the riser pipe 14 is set at a value of about 962 mm²; this corresponds to a diameter of about 35 mm. Riser pipes 14 with a larger diameter are not of interest due to the significant increase in the construction volume of the spraying device 1 that this would entail.

The ratio between the cross-sectional area 15 of flow in the riser pipe 14 and the cross-sectional area 16 of the outlet opening 11 should have a lower limit value of 25 and an upper limit value of 196 to achieve reasonable technical results. This corresponds, for example, to a diameter ratio of 10.1 mm for the riser pipe 14 and 2 mm for the outlet opening 11. The upper limit is defined by a diameter of the riser pipe 14 of 35 mm and a diameter of the outlet opening 11 of 2.5 mm.

1. A spraying device (1) for atomising and applying viscous media (5), the device comprising: a gun housing (2) having therein a delivery line (9), and a ring duct (10) enclosing the delivery line (9), and a blower (8) or a compressed air source by means of which a jet of air (24) is forced into the ring duct (10) through an inlet opening (25) in said gun housing (2), and a removable reservoir (4) attached to said gun housing (2) in which the medium (5) to be processed is filled and which is connected to the jet of air (24) from the ring duct (10) by means of a hose (13), and a riser pipe (14) in communication with the delivery line (9) and in the reservoir (4), through which the medium (5) can be forced towards the delivery line (9) by means of air pressure (40) generated by said blower (8), and a valve body (12) supported in the delivery line (9) in an axially mobile arrangement, by means of which an outlet opening (11) communicating with the delivery line (9) can be closed or opened,
and wherein
a cross-sectional surface (15) of said riser pipe (14) is 80 mm²-200 mm².

2. A spraying device (1) for atomising and applying viscous media (5), the device comprising a gun housing (2) having therein a delivery line (9) and a ring duct (10) enclosing the delivery line (9), and a blower (8) or a compressed air source by means of which a jet of air (24) is forced into the ring duct (10) through an inlet opening (25) in said gun housing (2), and a removable reservoir (4) attached to said gun housing (2) in which the medium (5) to be processed is filled and which is connected to the jet of air (24) from said ring duct (10) by means of a hose (13), and a riser pipe (14) in communication with the delivery line (9) and in said reservoir (4), through which the medium (5) can be forced through said riser pipe (14) towards the delivery line (9) by means of air pressure (40) generated by said blower (8), and with a valve body (12) supported in the delivery line (9) in an axially mobile arrangement, by means of which an outlet opening (11) communicating with the delivery line (9) can be closed or opened,
and wherein
the ratio between a cross-sectional area (15) of said riser pipe (14) and a cross-sectional area (16) of the outlet opening is between 25 and 41.

3. The spraying device in accordance with claim 1,
wherein
the air pressure (40) generated by said blower (8) has a positive pressure of 50 to 689 hPa (hectopascals) in relation to ambient air pressure in the area of the outlet opening (11).

4. The spraying device in accordance with claim 1, wherein
said riser pipe (14) consists of a pipe neck (19) and a supply neck (20) formed on said gun housing (2), the inner diameter of said pipe neck (19) is larger than the outer diameter of said supply neck (20), and said pipe neck (19) is pushed over the outer circumference of said supply neck (20).

5. The spraying device in accordance with claim 2, wherein
the length of a delivery section (18) of the delivery line (9) between the outlet opening (11) and the longitudinal axis (26) of said riser pipe (14) in said gun housing (2) is between 30 and 60 mm.

6. The spraying device in accordance with claim 5, wherein
a delivery section (17) of said riser pipe (14) and the delivery section (18) of the delivery line (9), taken together, are no more than 250 mm in length.

7. The spraying device in accordance with claim 1, wherein
said ring duct (10) in the area of the outlet opening (11) is divided into one or more flow ducts (24′, 24″) open towards the outside, and the flow ducts (24′, 24″) are aligned towards a jet of paint (5′) emerging from the outlet opening (11) in such a way that the jet of air (24′, 24″) emerging from the flow ducts (21) atomises and compresses the jet of media (5′) in an area of a longitudinal axis of said gun housing (2).
